(19) United States
(12) Patent Application Publication
(10) Pub. No.: US 2017/0068989 A1
(43) Pub. Date: Mar. 9, 2017

(54) METHOD AND SYSTEM FOR REAL-TIME CURATED CATEGORY AND SOCIAL MEDIA ADVERTISING

(71) Applicant: WAL-MART STORES, INC., Bentonville, AR (US)

(72) Inventors: Sreekalian Deepak Reddy, Bangalore (IN); Chihung Yu, Santa Clara, CA (US); Yan Zheng, San Jose, CA (US)

(73) Assignee: WAL-MART STORES, INC., Bentonville, AR (US)

(21) Appl. No.: 14/846,593

(22) Filed: Sep. 4, 2015

(51) Int. Cl. G06Q 30/02

(52) U.S. Cl. CPC G06Q 30/0257; G06Q 30/0277

(57) ABSTRACT

A system and method for real-time curated category and social media advertising is presented. A system can include a modulator module, a syncer module, a ranking module, a database interface, and a sharing module. The syncer is configured to monitor the modulator module to ensure that new custom-curated shelves or collections are accounted for. The ranking module is configured to track the ranking of each product in a shelf such that the products are listed according to rankings. The database interface allows the system to display relevant information regarding each item in a shelf. The sharing module is configured to interface with social media services to promote shelves. Other embodiments are also disclosed herein.

### TECHNICAL FIELD

This disclosure relates generally to on-line retail sales and more particularly to a method and system for displaying and maintaining custom curations of products for display to customers.

### BACKGROUND

An electronic commerce (“eCommerce”) provider will typically maintain a website and/or a mobile app that allows customers to search and browse through the eCommerce provider's goods and services. It can be desirable for the eCommerce provider to showcase one or more goods or collections of goods that can be desirable to potential customers. It can be desirable for the showcase of goods or collections of goods to be easily maintained and publicized.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system;

FIG. 2 illustrates a representative block diagram of an example of the elements included in the circuit boards inside a chassis of the computer system of FIG. 1;

FIG. 3 is a representative block diagram of a system according to an embodiment;

FIG. 4 is an exemplary screen shot of an eCommerce website;

FIG. 5 is an exemplary screen shot of an eCommerce website after a user has selected a shelf for viewing;

FIG. 6 is a block diagram of a system capable of performing embodiments; and

FIG. 7 is a flowchart illustrating the operation of an embodiment.

For simplicity and clarity of illustration, the drawing figures illustrate the general manner of construction, and descriptions and details of well-known features and techniques might be omitted to avoid unnecessarily obscuring the present disclosure. Additionally, elements in the drawing figures are not necessarily drawn to scale. For example, the dimensions of some of the elements in the figures might be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but might include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In one embodiment, a system might comprise: a modulator module configured to allow the creation of an on-line shelf comprising a list of item identifiers for display as a custom curation of related items; a syncer module coupled to the modulator module; a ranking module coupled to the syncer module, the ranking module configured to provide information related to sales to the syncer module; and a database interface coupled to the syncer module, the database interface configured to allow the syncer module to access an external database; wherein the syncer module is configured to: receive the on-line shelf from the modulator module; retrieve information about each item identifier using a database interface module; and cause the information about each item identifier to be displayed to a user after a request from the user.

In one embodiment, a system might comprise: one or more processing modules; and one or more non-transitory storage modules storing computing instructions configured to run on the one or more processing modules and perform the acts of: receiving an on-line shelf from a modulator module, wherein the on-line shelf comprises an electronic list of item identifiers for display as a custom curation of related items; retrieving information about each item identifier using a database interface module; causing the information about each item identifier to be displayed to a user after a request from the user.

In one embodiment, a method might comprise: receiving an on-line shelf from a modulator module, wherein the on-line shelf comprises an electronic list of item identifiers for display as a custom curation of related items; retrieving information about each item identifier using a database interface module; and causing the information about each item identifier to be displayed to a user after a request from the user.

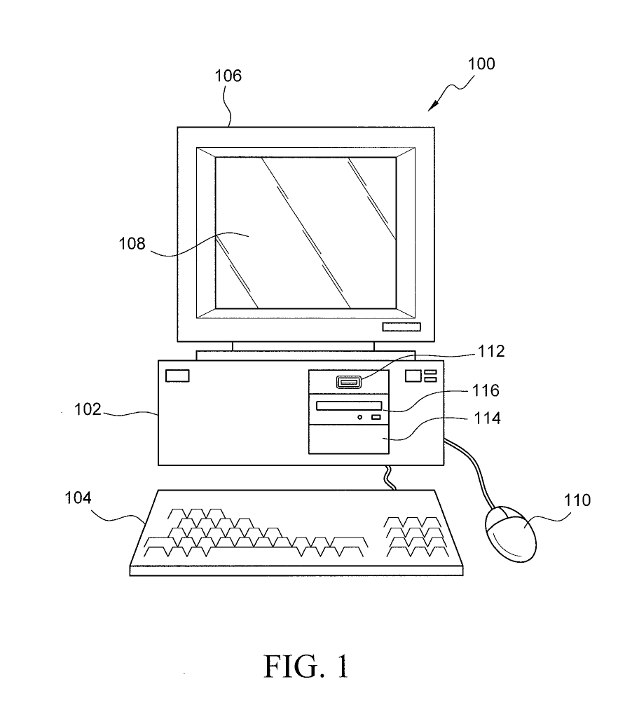

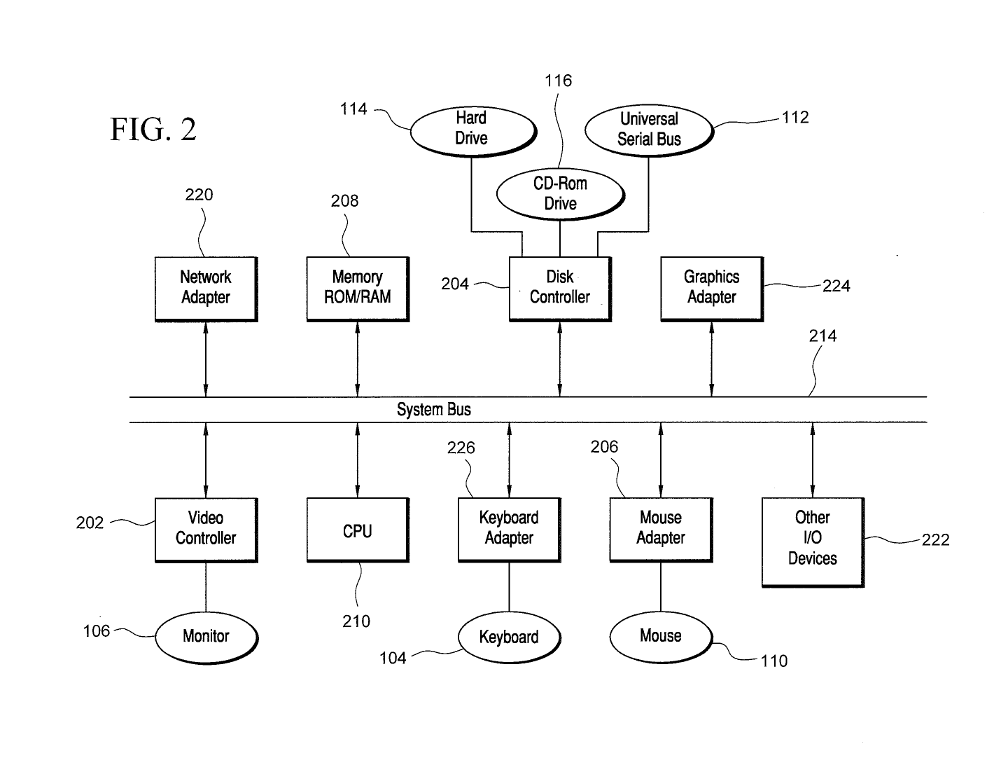

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) also can be appropriate for implementing the techniques described herein. Computer system 100 comprises chassis 102 containing one or more circuit boards (not shown), a Universal Serial Bus (USB) port 112, a Compact Disc Read-Only Memory (CD-ROM), Digital Video Disc (DVD) drive, or Blu-ray drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS) or Unified Extensible Firmware Interface (UEFI). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM, DVD drive, or Blu-ray drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise various versions/distributions of Microsoft® Windows® operating system (OS), Apple® OS X, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

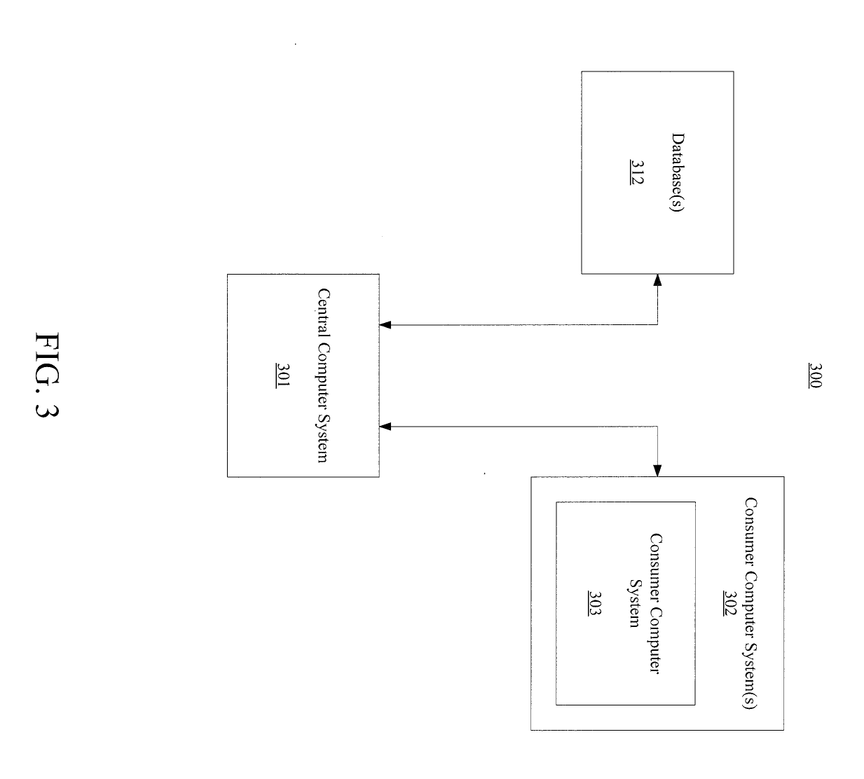

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

As further described in greater detail below, in these or other embodiments, system 300 can proactively (e.g., prospectively) and/or reactively (e.g., responsively) determine and/or communicate the consumer product information to the consumer, as desired. Proactive acts can refer to acts (e.g., identification, determination, communication, etc.) performed without consideration of one or more predetermined acts performed by the consumer; and reactive acts can refer to acts (e.g., identification, determination, communication, etc.) performed with consideration of (i.e., in response to) one or more predetermined acts performed by the consumer. For example, in some embodiments, the predetermined act(s) can comprise an act of identifying a selection of a consumer product by the consumer.

Meanwhile, as also described in greater detail below, system 300 can be implemented in brick-and-mortar commerce and/or electronic commerce applications, as desirable. Further, in many of these or other embodiments, system 300 can communicate the consumer product information to the consumer substantially in real-time (e.g., near real-time). Near real-time can mean real-time less a time delay for processing (e.g., determining) and/or transmitting the relevant consumer product information to the relevant consumer. The particular time delay can vary depending on the type and/or amount of the consumer product information, the processing speed(s) of the processing module(s) of system 300, the transmission capability of the communication hardware (as introduced below), the transmission distance, etc. However, in many embodiments, the time delay can be less than approximately one, five, ten, or twenty minutes.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specifically, system 300 comprises a central computer system 301. In many embodiments, central computer system 301 can be similar or identical to computer system 100 (FIG. 1). Accordingly, central computer system 301 can comprise one or more processing modules and one or more memory storage modules (e.g., one or more non-transitory memory storage modules). In these or other embodiments, the processing module(s) and/or the memory storage module(s) can be similar or identical to the processing module(s) and/or memory storage module(s) (e.g., non-transitory memory storage modules) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touchscreen displays, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of central computer system 301. In a similar manner, the processing module(s) and the memory storage module(s) can be local and/or remote to each other.

In many embodiments, central computer system 301 is configured to communicate with one or more consumer computer systems 302 (e.g., a consumer computer system 303) of one or more consumers. For example, the consumer(s) can interface (e.g., interact) with central computer system 301, and vice versa, via consumer computer system(s) 302 (e.g., consumer computer system 303). Accordingly, in many embodiments, central computer system 301 can refer to a back end of system 300 operated by an operator and/or administrator of system 300, and consumer computer system(s) 302 can refer to a front end of system 300 used by one or more users of system 300 (i.e., the consumer(s)). In these or other embodiments, the operator and/or administrator of system 300 can manage central computer system 301, the processing module(s) of computer system 301, and/or the memory storage module(s) of computer system 301 using the input device(s) and/or display device(s) of central computer system 301. In some embodiments, system 300 can comprise consumer computer system(s) 302 (e.g., consumer computer system 303).

Like central computer system 301, consumer computer system(s) 302 each can be similar or identical to computer system 100 (FIG. 1), and in many embodiments, each of consumer computer system(s) 302 can be similar or identical to each other. In many embodiments, consumer computer system(s) 302 can comprise one or more desktop computer devices, one or more wearable user computer devices, and/or one or more mobile devices, etc. At least part of central computer system 301 can be located remotely from consumer computer system(s) 302.

In some embodiments, a mobile device can refer to a portable electronic device (e.g., an electronic device easily conveyable by hand by a person of average size) with the capability to present audio and/or visual data (e.g., images, videos, music, etc.). For example, a mobile device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can comprise a volume and/or weight sufficiently small as to permit the mobile device to be easily conveyable by hand. For examples, in some embodiments, a mobile device can occupy a volume of less than or equal to approximately 189 cubic centimeters, 244 cubic centimeters, 1790 cubic centimeters, 2434 cubic centimeters, 2876 cubic centimeters, 4056 cubic centimeters, and/or 5752 cubic centimeters. Further, in these embodiments, a mobile device can weigh less than or equal to 3.24 Newtons, 4.35 Newtons, 15.6 Newtons, 17.8 Newtons, 22.3 Newtons, 31.2 Newtons, and/or 44.5 Newtons.

Exemplary mobile devices can comprise, but are not limited to, one of the following: (i) an iPod®, iPhone®, iPod Touch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia®, Surface Pro™, or similar product by the Microsoft Corporation of Redmond, Wash., United States of America, and/or (iv) a Galaxy™, Galaxy Tab™, Note™, or similar product by the Samsung Group of Samsung Town, Seoul, South Korea. Further, in the same or different embodiments, a mobile device can comprise an electronic device configured to implement one or more of (i) the iOS™ operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by Google, Inc. of Mountain View, Calif., United States, (v) the Windows Mobile™, Windows Phone™, and Windows 10 (Mobile)™ operating systems by Microsoft Corporation of Redmond, Wash., United States of America, or (vi) the Symbian™ operating system by Nokia Corp. of Keilaniemi, Espoo, Finland.

In further embodiments, central computer system 301 can be configured to communicate with software (e.g., one or more web browsers, one or more mobile software applications, etc.) of the consumer computer system(s) 302 (e.g., consumer computer system 303). For example, the software can run on one or more processing modules and can be stored on one or more memory storage modules (e.g., one or more non-transitory memory storage modules) of the consumer computer system(s) 302 (e.g., consumer computer system 303). In these or other embodiments, the processing module(s) of the consumer computer system(s) 302 (e.g., consumer computer system 303) can be similar or identical to the processing module(s) described above with respect to computer system 100 (FIG. 1). Further, the memory storage module(s) (e.g., non-transitory memory storage modules) of the consumer computer system(s) 302 (e.g., consumer computer system 303) can be similar or identical to the memory storage module(s) (e.g., non-transitory memory storage module(s)) described above with respect to computer system 100 (FIG. 1). Exemplary web browsers can include (i) Firefox® by the Mozilla Organization of Mountain View, Calif., United States of America, (ii) Internet Explorer® by the Microsoft Corp. of Redmond, Wash., United States of America, (iii) Chrome™ by Google Inc. of Menlo Park, Calif., United States of America, (iv) Opera® by Opera Software of Oslo, Norway, and (v) Safari® by Apple Inc. of Cupertino, Calif., United States of America.

Meanwhile, in many embodiments, central computer system 301 also can be configured to communicate with one or more databases 312. The database can comprise a product database that contains information about products sold by a retailer. Database(s) 312 can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of database(s) 312, that particular database can be stored on a single memory storage module of the memory storage module(s) and/or the non-transitory memory storage module(s) storing database(s) 312 or it can be spread across multiple of the memory storage module(s) and/or non-transitory memory storage module(s) storing database(s) 312, depending on the size of the particular database and/or the storage capacity of the memory storage module(s) and/or non-transitory memory storage module(s).

In these or other embodiments, the memory storage module(s) of central computer system 300 can comprise some or all of the memory storage module(s) storing database(s) 312. In further embodiments, some of the memory storage module(s) storing database(s) 312 can be part of consumer computer systems 302 and/or one or more third-party computer systems (i.e., other than central computer system 301 and consumer computer systems 302), and in still further embodiments, all of the memory storage module(s) storing database(s) 312 can be part of consumer computer systems 302 and/or the third-party computer system(s). Like central computer system 301 and consumer computer system(s) 302, when applicable, each of the third-party computer system(s) can be similar or identical to computer system 100 (FIG. 1). Notably, the third-party computer systems are omitted from the drawings to better illustrate that database(s) 312 can be stored at memory storage module(s) of central computer system 301, consumer computer system(s) 302, and/or the third-party computer systems, depending on the manner in which system 300 is implemented.

Database(s) 312 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between central computer system 301, consumer computer system(s) 302 (e.g., consumer computer system 303), and/or database(s) 312 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, and the like. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.)

For convenience, the functionality of system 300 is described herein as it relates particularly to consumer computer system 303 and a single consumer. But in many embodiments, the functionality of system 300 can be extended to each of consumer computer system(s) 302 and/or to multiple consumers. In these extended examples, in some embodiments, single consumers can interface (e.g., interact) with central computer system 301 with multiple consumer computer systems of consumer computer system(s) 302 (e.g., at different times). For example, a consumer could interface with central computer system 301 via a first consumer computer system (e.g., a desktop computer), such as, for example, when interfacing with central computer system 301 from home, and via a second consumer computer system (e.g., a mobile device), such as, for example, when interfacing with central computer system 301 away from home.

Electronic commerce (eCommerce) is a steadily growing portion of the retail sector. In 2014, eCommerce sales were over $300 billion. eCommerce sales have been growing with over ten percent (10%) growth rate each year for over a decade. As more and more products become available for sale to users over the Internet, the desire to manage the number of choices available to consumers becomes greater. In addition, as eCommerce sales continues to grow, there is a desire among eCommerce retailers to distinguish themselves from their competitors by providing a better experience for customers.

One method of satisfying both the desire to manage the number of choices available to consumers and to provide a better experience for the customers is to provide a curated user experience. A curated user experience typically involves helping customer discover products based on their personal preferences and seasonal needs. Personal preferences can be tracked, for example, through the use of cookies. As a user browses through various items on an eCommerce site, the items he looks at is tracked and can be used to provide a list of recommended items to the user. In addition, seasonal sales can be used as variables to further modify the list of recommended items to the user. For example, an upcoming holiday (such as Mother's Day, Valentine's Day, or Halloween) can trigger various products to be displayed to a user.

There can be several problems with such a set-up. The presentation of items might only be related to items previously viewed by the customer. Thus, a particular customer will not be shown any camping gear unless the customer actually views camping gear first. In addition, the curation of seasonal products is typically manual and might be updated relatively slowly (e.g., daily). In addition, the rapid adoption of social media sites (e.g., Facebook, Twitter, Instagram, Pinterest, and the like) by potential customers might cause some eCommerce sites to want to post curated lists to those social media sites in order to drive customers to the eCommerce site for a variety of reasons. For example, because so many potential customers are using social media sites, it can be desirable for an eCommerce provider to have its curated lists to be published on the sites. In addition, social media allows a customer to “like,” “favorite,” or “retweet” a curated list to the customer's friends or followers, giving more weight to a curated list. Posting a curated list on a social media site process must be accomplished manually in the prior art. It would be desirable to create a streamlined process to solve the above-listed problems.

In some embodiments, there can be special selections of related products that are presented to customers of an eCommerce site. A selection can be termed a “shelf” in some embodiments. Other embodiments can use different terminology, such as collection or curation or similar terms. They will be referred to as shelves in this disclosure. These shelves can be themed, with the themes chosen based on variables such as location, season, and sales. For example, there can be themes based around upcoming holidays (e.g., Valentine's Day, Easter, Mother's Day, Halloween, Thanksgiving, and Christmas). There can be themes based around upcoming movie or video game releases. There can be themes based around the time of the year (e.g., back to school items, camping items, swimwear, winter wear, etc.) There can be localized themes (e.g., ski-related items being displayed to users close to mountainous regions, water-related items being displayed to users close to water regions). Each of these themes can have a curated “shelf.”

A shelf can have items that are selected because of their relationship to the theme. For example, if the theme of a shelf is back to school, there can be school supplies, backpacks, clothing, dorm furniture, computers, electronics, and the like. A shelf can also have items selected because of a sale. For example, only certain computers might be on sale, so those specific computers are the ones displayed on the shelf Specialty retailers can have shelves that are more specific to the products that they sell. For example, while a more general retailer might have a shelf for “sporting goods” that have items specific to many different sports, a sporting goods retailer can have separate shelves directed to separate sports, such as baseball, basketball, football, and golf. An electronics retailer can have separate shelves directed to hard drives, printers, and monitors. A jewelry retailer can have separate shelves directed to watches, bracelets, earrings, and necklaces.

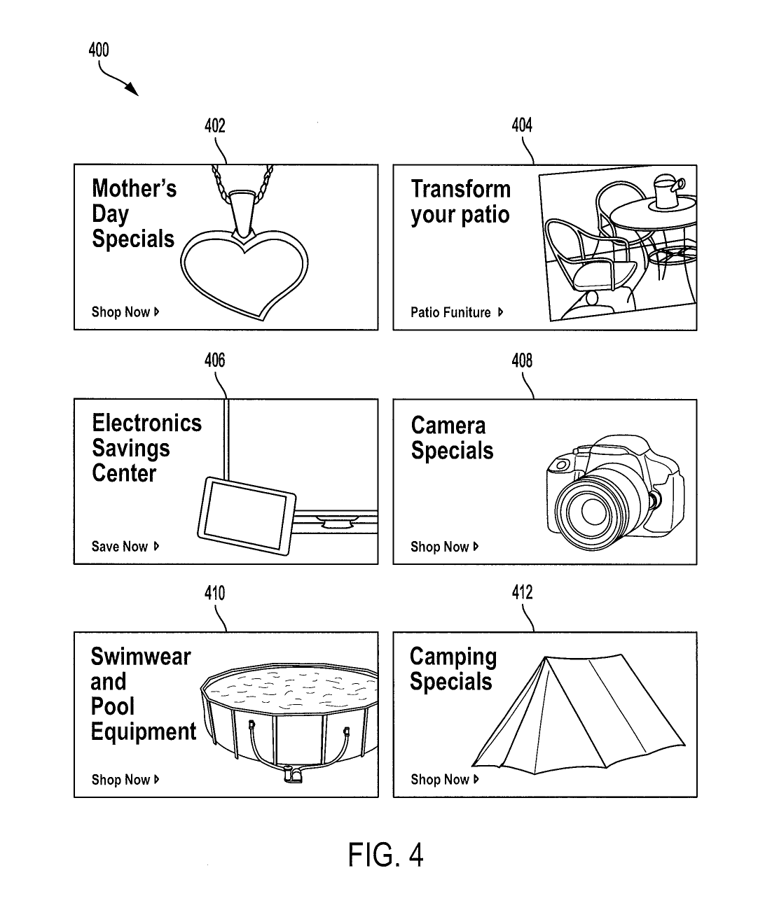

The display of shelves to a customer can be in a variety of different manners. FIG. 4 presents an exemplary screen shot 400 of an eCommerce website displaying available shelves. Screen shot 400 can be displayed to a customer via a web page accessible on a browser, via an app accessibly via a mobile electronic device (such as a smartphone, electronic reader, or tablet), and the like.

Screen shot 400 displays a variety of different boxes to the customer. Each of the boxes will lead the customer to a shelf Displayed in screen shot 400 are box 402, leading a user to a Mother's Day shelf, box 404 leading a user to a patio shelf, box 406 leading a user to a collection of electronics, box 408 featuring camera equipment, box 410 featuring swimming-related goods, and box 412 featuring camping-related goods. When a customer selects one of the boxes, a web page/app page is displayed to the customer.

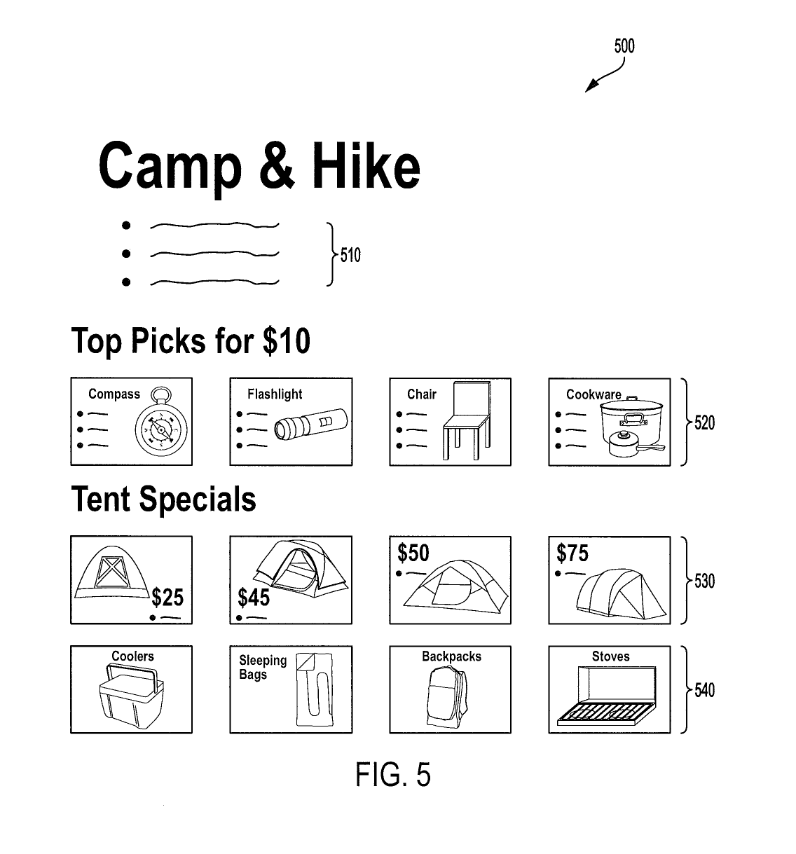

FIG. 5 presents an exemplary screen shot 500 of an eCommerce website after a user has selected box 412 (FIG. 4) featuring camping-related goods. Screen shot 500 can display a variety of different items that can be desirable to a user. For example, there can be a description 510 that presents an overview of the shelf. This description can help a customer in choosing products that would be useful for the selected shelf. For example, description 510 can describe key items needed for a camping trip or recent advancements in camping technology.

There can be a variety of different items related to camping displayed in item list 520. In the example shown in screen shot 500, item list 520 can display top-rated camping accessories under ten dollars ($10). There can be multiple such lists, such that item list 530 can display various tents. There can be a variety of different categories displayed in category list 540. Category list 540 can lead to other shelves related to camping. In the example shown in FIG. 5, category list 540 can include categories such as cooking equipment, camping accessories, knives and tools, backpacks, lights, and a variety of other camping-related categories. Each of the item lists and category lists can be scrollable, such that additional items are selectable by a customer.

The creation and display of web pages and/or presentations on mobile devices can be accomplished by a variety of means, both now known in the art or developed in the future. For example, a user may be using a computer system similar to one or more of consumer computer system(s) 302 (of FIG. 3). Consumer computer system(s) 302 can be connected to the Internet. Consumer computer system(s) 302 can be a desktop computer, a laptop computer, or a mobile device. By connecting consumer computer system(s) 302 to the Internet, consumer computer system(s) 302 can retrieve a web page or data formatted for display on a mobile device. The web page can contain information formatted such that when a browser or mobile app accesses the information, the information is displayed in a manner that results in the screen shots of FIG. 4 or 5. Exemplary methods of formatting information includes the use of markup languages, style sheets, and the like to display text and images in a formatted manner.

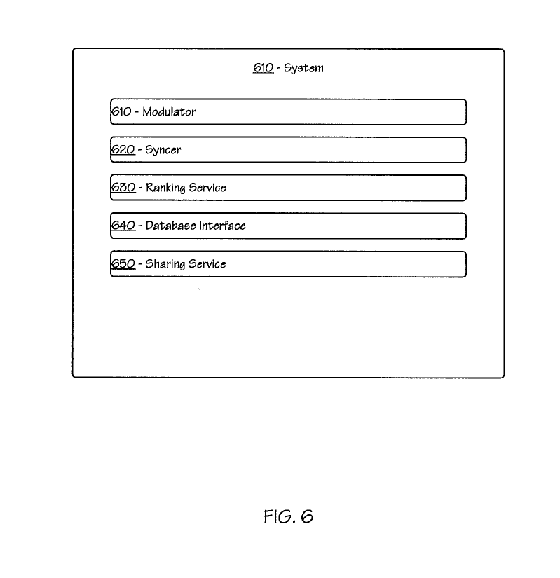

Turning ahead in the figures, FIG. 6 illustrates a block diagram of a system 600 that is capable of performing disclosed embodiments. System 600 is merely exemplary and is not limited to the embodiments presented herein. System 600 can be employed in many different embodiments or examples not specifically depicted or described herein. In some embodiments, certain elements or modules of system 600 can perform various procedures, processes, and/or acts. In other embodiments, the procedures, processes, and/or acts can be performed by other suitable elements or modules.

System 600 contains a variety of different operating blocks. There can be a modulator 610, a syncer 620, ranking service 630, database interface 640, and a sharing service 650. The operation of these operating blocks will be discussed in more detail below. Briefly, modulator 610 serves to allow an eCommerce retailer to create a custom curated shelf. Modulator 610 can also allow an eCommerce retailer to automatically create a shelf (e.g., a “top 10 sellers” shelf). Syncer 620 allows the rest of system 600 to interface with modulator 610, in order to determine if any custom shelves have been created. Ranking service 630 tracks the ranking of various items in each shelf, allowing each shelf to dynamically react to the popularity of items within the shelf. Database interface 640 allows system 600 to interface with a product database to display product information to customers. Sharing service 650 allows the system to interface with various social media services to promote products and shelves.

The modulator 610 can operate in one of a variety of different manners. In some embodiments, modulator 610 allows an eCommerce retailer to select a group of items (or stock keeping units (SKUs)) as a curated shelf. In general, a modulator 610 allows a person (such as an employee of the eCommerce retailer), to select multiple SKUs that will be grouped together in a shelf Modulator 610 can also be configured to allow the employee to title the shelf, enter a description of the shelf, and the like. Modulator 610 can also be configured to host each of the created shelves. Hosting a shelf can mean that modulator 610 has a list of each shelf, along with pertinent information related to each shelf, as will be described in further detail below. In some embodiments, a shelf contains a list of each stock keeping unit (SKU) within a shelf, each SKU being associated with a unique identifier. In some embodiments, a shelf can also include informational text or images that can be used to describe the shelf.

Modulator 610 can be configured in a variety of different manners. In some embodiments, modulator 610 can be a web-based application configured to operate in a browser window. In such an embodiment, a user could use search terms to find products to place in a shelf, then make an indication (such as a toggle box or check mark) to indicate the desire to place the selected item in a shelf After a shelf is created, the SKUs in the shelf are stored in a database. An exemplary database may include the SKUs of a shelf, a unique identifier associated with the shelf, a timestamp indicating the date and/or time a shelf was modified, a date field indicating the scheduled time for a shelf to become active, and the like.

Syncer 620 is a module that periodically polls modulator 610 to determine if new shelves have been created or if existing shelves have been modified. As described above, in some embodiments, a shelf comprises a list of items. In some embodiments, the list of items might contain only a SKU or other unique identifier code for each item in the shelf. The shelf also might contain a title that describes the shelf, text describing the shelf, images related to the shelf, and the like. A timestamp can be automatically generated to indicate the time at which the shelf was created or last modified. The timestamp can be stored in a variety of different manners (e.g., Unix time, network time protocol, and the like) that indicate the time at which the shelf was created or last modified.

Syncer 620 has a list of shelves that are currently hosted on the eCommerce website, each with a corresponding timestamp of when the shelf was last modified. In some embodiments, syncer 620 is the module that pushes the shelves out to the eCommerce website. In other words, syncer 620 determines which shelves are active (e.g., available for viewing by customers). Syncer 620 periodically checks the shelves being hosted by modulator 610 and the timestamp of the shelf being hosted by modulator 610. In some embodiments, this periodic check can be performed every five minutes. In other embodiments, the periodic check can be performed hourly. Other time periods can be used. If the timestamp of the shelf hosted by modulator 610 is newer than the timestamp of the shelf hosted by syncer 620, syncer 620 can modify the shelf to include the newly listed content. Similarly, modulator 610 can stop hosting a shelf that is no longer active, or host a shelf that was not previously active. In the latter case, syncer 620 can compare the shelves hosted by modulator 610 to determine if there are any shelves that are not currently active. If it finds an inactive shelf, syncer 620 can obtain the shelf information from modulator 610 and make the shelf active in a manner described later. The shelf also might contain a scheduled time. In other words, an eCommerce retailer might desire that a shelf only be available to customers at a certain time or might desire that a shelf cease being displayed at a certain time. In such a case, syncer 620 can be configured to examine each shelf to determine if each shelf has a scheduled start time and/or a scheduled end time. If the shelf has a scheduled start time and the scheduled start time has passed, syncer 620 can be configured to allow the shelf with the scheduled start time to be displayed. Similarly, if the shelf has a scheduled end time, once the schedule end time has passed, syncer 620 can be configured to stop displaying the shelf (making the shelf inactive). Scheduled start time and end times can allow special promotions such as short-term sales, where a group of items is only on sale for a short period of time. During busy shopping seasons, such as Black Friday or Cyber Monday (the Friday and Monday after Thanksgiving, respectively) a shelf can be active for a very short period of time, sometimes an hour or less.

Each shelf also can have multiple versions. In some embodiments, a database entry for a shelf can have a version ID that identifies the version number of a shelf Syncer 620 can then be configured to compare the version number of an active shelf with the version number of a shelf in modulator 610. A shelf can have versions for a variety of different reasons. For example, one who creates a shelf might create a preliminary version and later decide to include different items in the shelf In another example, an item might become sold out, and the eCommerce retailer might decide to then promote a similar item that is not sold out. A new version of a shelf can be created to reflect the new contents of the shelf.

In some embodiments, different versions can be scheduled to become active at different times. For example, a camping shelf can have one set of tents active for a first time period and a second set of tents active for a second time period. In such a manner, an eCommerce provider can compare the sales data for tents for research purposes.

Ranking service 630 is a module arranged to determine the relative sales activity of the items in each shelf. This can be accomplished in a variety of different manners. In typical eCommerce systems, the sales of the products sold by the eCommerce provider is tracked with every sale. Ranking service 630 can obtain the sales information as it is being tracked. Ranking service 630 can also obtain a list of items in each shelf from syncer 620. Ranking service 630 correlates the sales information with the list of items in each shelf to determine which items in a shelf have the highest sales. The ranking information can be limited or filtered by timeframe. For example, the rank can be limited to the past 24 hours, the past 72 hours, the past week, the past month, or any other suitable time frame. After ranking information is obtained from appropriate sources, the ranking information can be used for displaying the items in each shelf.

For example, referring back to FIG. 5, the camping shelf can list five different tents that can be of interests to customers looking for camping equipment. After the shelf is created (such as through the use of modulator 610), the five tents can be listed in a variety of different orders. The tents could be listed alphabetically by brand. The tents also could be listed by cost, or customer rating, or one of a variety of other different manners. The order of the listing can be controlled by the creator of a shelf, such as through an entry in a database that indicates the order of display.

Ranking service 630 allows the tents to be listed in order of sales. In such a manner, after the above-described camping shelf has been created and one of tents in the shelf has become more popular among customers, that popularity can result in that particular tent receiving a more prominent placement on the shelf (such as being displayed first or being displayed in a more prominent manner). The popularity can be analyzed based on seasonal or other variations such that different tents (for example) might be more popular in the summer versus the spring or fall. Whether the popularity is due to a good sale price, positive customer reviews, or a combination of factors, the popularity of an item might lead to other customers also wanting to order the item or view information about the item. Thus, it might be of interest to an eCommerce providers to place the better selling items in a more prominent place.

Database interface 640 is configured to allow the eCommerce provider to display the shelves in a manner that the eCommerce provider finds appropriate. As discussed above, the minimum information needed for a shelf is a list of SKUs. Other information also can be stored for a shelf, such as a title of the shelf and one or more textual descriptions or images relevant to the shelf. To create a shelf, however, one can begin with only the list of SKUs. For optimum user experience of a customer using an eCommerce provider's web site or mobile app, it would be desirable if the eCommerce provider's web site or mobile app did more than just show a list of SKUs.

In some embodiments, the shelves are contained in a separate database. In some embodiments, that separate database is a No SQL database using a key-value store (KV store) format, where instead of using a typical database format of many different columns for each row, the only value stored is a unique identifier that identifies that SKU. Database interface 640 is configured to serve as a link between a database storing the shelf and a database storing information about each SKU.

In general, an eCommerce provider can have multiple databases. There can be one or more databases containing customer information. There can be one or more database containing information about the products being sold. There can be one or more databases containing availability information. The product information can include a title, a description, specifications (size, color, etc.), options, price, images, and the like.

In some embodiments, database interface 640 is configured to access one or more product databases to obtain information about each product in a shelf Database interface 640 can be further configured to use the information about each product and display the information to the user. This can be accomplished in one of a variety of different manners. For example, a dynamic web page can be used to display web pages to users. The dynamic web page can access database interface 640 and display information related to each shelf.

In some embodiments, a cache memory is used to store some portions of each shelf Database interface 640 can be configured to store a unique identifier for each shelf that is active. The cache memory can be configured to store additional information about each shelf Stored in the cache memory can be an identifier for each shelf, a version number of the shelf, and a timestamp of the last update to the shelf. The purpose of the cache memory would be to allow quicker monitoring of the contents of the shelf Rather than database interface 640 needing to access one or more databases in order to find out which shelf is currently being displayed on the eCommerce provider's website, database interface 640 would only need to access the cache. Accessing a cache memory is much quicker than having to access one or more databases. If database interface 640 attempts to retrieve information for a shelf from the cache memory but is unsuccessful, database interface 640 can be configured to retrieve the information from the one or more databases.

Sharing service 650 is configured to broadcast information about a shelf Social media is widely used by many people. Sites like Twitter, Facebook, Instagram, and the like can be used by people and by companies as a way to communicate information to users. It can be desirable to use social media sites to promote shelves that have been created. For example, a shelf might have been created that highlights an eCommerce retailer's popular sales during Black Friday. The eCommerce retailer might believe that promoting the sale using social media platforms such as Twitter, Facebook, Instagram, and the like.

The promotion of the shelves can be accomplished in a variety of different manners. The various social media sites might have an application programming interface (API) with parameters and settings that are known to those of skill in the art. For example, Facebook has the “Graph API” and other APIs that can allow developers to retrieve information from Facebook and post information to Facebook. Similarly, Twitter has a several available APIs with known specifications that can allow a developer to post information to Twitter.

In some embodiments, sharing service 650 can be configured to periodically make a post on a social media site, using an API. This can be done at any timing desired. For example, the post can be made at specific times of the day that the eCommerce provider has determined is an appropriate time to make a post. For example, the post can be made at both 9 am Eastern Daylight time and 9 am Pacific Daylight time, in an attempt to publicize the shelf for the broadest number of potential American customers. The post can be made on different networks (e.g., Facebook and Twitter) at different times, if the eCommerce provider has discovered different response rates between different social media sites. The post can be made whenever a shelf has been changed or at the scheduled time when a shelf becomes active. The post can be made hourly, every two hours, daily, and the like.

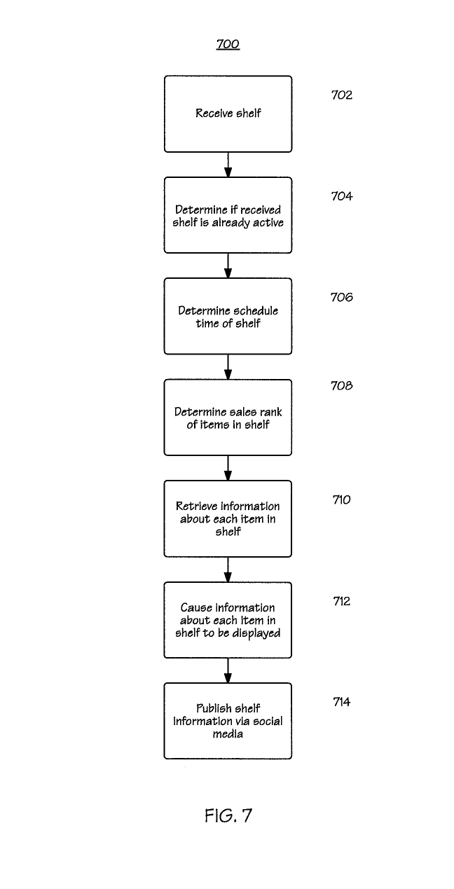

FIG. 7 will now show a flowchart illustrating the operation of a method 700 of initializing the clusters of a clustering algorithm is disclosed. Method 700 is merely exemplary and is not limited to the embodiments presented herein. Method 700 can be employed in many different embodiments or examples not specifically depicted or described herein. In some embodiments, the procedures, the processes and/or the activities of method 700 can be performed in the order presented. In other embodiments, the procedures, the processes, and/or the activities of method 700 can be performed in any other suitable order. In still other embodiments, one or more of the procedures, the processes, and/or the activities of method 700 can be combined or skipped. In some embodiments, method 700 can be implemented by computer system 100 (FIG. 1). In some embodiments, method 700 can be implemented by syncer 620 (FIG. 6).

A shelf is received from a modulator module (block 702). The shelf comprises a list of item identifiers. It is determined if the shelf is already currently active (block 704). This can be accomplished in a variety of different manners. In some embodiments, syncer 620 has a list of every active shelf, with each shelf being associated with a unique identifier. To determine if a shelf is active, the list of active shelves is accessed, and the unique identifier of each shelf is compared to the unique identifier of the shelf received in block 702. A shelf also can include a scheduled time that indicates when the shelf is to become active. The scheduled time is compared to a current time (block 706). If the scheduled time is before the current time, method 700 can end with respect to the received shelf. If the scheduled time has already occurred, the received shelf is made active. A variety of other tasks can also be performed. For example, each shelf might contain a version number. The version number of an active shelf can be compared to the version number of the shelf received from a modulator module. If the version number is less than or equal to the version number of the active shelf, than method 700 can end with respect to the received shelf. If the version number of the received shelf is greater than the version number of the active shelf, the remainder of method 700 can be performed.

The sales rank of each of the unique identifiers is determined (block 708) and can be used to determine the order to display the identifiers in the shelf Information about each item identifier listed in the shelf is retrieved from an external database (block 710). Thereafter, a system performing method 700 can cause the information about each item identifier to be published or displayed to a user, after a request from the user (block 712). This can be accomplished in a variety of different manners. For example, a web page can be created that contains information about the shelf. The information can include the items contained in the shelf, information about each item (for example, a title, description, price, image, and the like), etc. The web page can be created in a variety of different manners, and a user can use a variety of different tools (such as a browser or a mobile app) to access the web page.

Information about the shelf can be published via social media (block 714). Publication via social media can be scheduled, or it can occur when a shelf is published. An entry in a database can be made to indicate that the shelf is now active. Also stored with that entry can be information such as the time the shelf became active and the version number of the shelf There can also be an expiration date/time for a shelf. Once the expiration date/time has been reached, the shelf is marked as inactive and will no longer be available to be viewed by a user.

Although the above embodiments have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 can be modified, and that the foregoing discussion of certain of these embodiments does not necessarily represent a complete description of all possible embodiments. For example, one or more of the procedures, processes, or activities of FIGS. 1-7 can include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a modulator module configured to allow the creation of an on-line shelf comprising a list of item identifiers for display as a custom curation of related items;
a syncer module coupled to the modulator module;
a ranking module coupled to the syncer module, the ranking module configured to provide information related to sales to the syncer module; and
a database interface coupled to the syncer module, the database interface configured to allow the syncer module to access an external database;
wherein the syncer module is configured to:
receive the on-line shelf from the modulator module;
retrieve information about each item identifier using a database interface module; and
cause the information about each item identifier to be displayed to a user after a request from the user.

2. The system of claim 1 further comprising:
a sharing module coupled to the syncer module;
wherein:
the sharing module is configured to cause an update to be posted on a social media platform featuring the on-line shelf by accessing an application program interface (API) related to the social media platform.

3. A system comprising:
one or more processing modules; and
one or more non-transitory storage modules storing computing instructions configured to run on the one or more processing modules and perform the acts of:
receiving an on-line shelf from a modulator module, wherein the on-line shelf comprises an electronic list of item identifiers for display as a custom curation of related items;
retrieving information about each item identifier using a database interface module;
causing the information about each item identifier to be displayed to a user after a request from the user.

4. The system of claim 3 wherein the computing instructions further comprise:
receiving ranking information about each item identifier; and
using the ranking information to determine an order in which to display the electronic list of item identifiers of the on-line shelf.

5. The system of claim 3 wherein the computing instructions further comprise:
causing an update to be posted on a social media platform featuring the on-line shelf, by accessing an application program interface (API) related to the social media platform.

6. The system of claim 3 wherein the computing instructions further comprise:
periodically accessing the modulator module to determine if the on-line shelf has been modified; and
if the on-line shelf has been modified, causing information about the modified on-line shelf to be displayed.

7. The system of claim 3 wherein:
the on-line shelf further comprises a scheduled time configured to indicate a time at which the on-line shelf is to be modified; and
the method further comprises:
comparing a present time to the scheduled time; and
causing information about the modified on-line shelf to be displayed when the present time is past the scheduled time.

8. The system of claim 7 wherein:
the on-line shelf further comprises a version number; and
the computing instructions further comprise:
comparing the version number to a version number of an active on-line shelf; and
causing the on-line shelf with a higher version number to be displayed.

9. The system of claim 3 wherein:
the on-line shelf further comprises an expiration time configured to indicate a time after which the on-line shelf become inactive.

10. The system of claim 10 wherein:
causing the information about each item identifier to be displayed comprises:
retrieving information associated with each item identifier to be displayed from an external database; and
transmitting the information associated with each item identifier in a format that is configured to be displayed to the user.

11. The system of claim 10 wherein:
the information associated with each item identifier includes description information and price information associated with each item identifier.

12. A method comprising:
receiving an on-line shelf from a modulator module, wherein the on-line shelf comprises an electronic list of item identifiers for display as a custom curation of related items;
retrieving information about each item identifier using a database interface module; and
causing the information about each item identifier to be displayed to a user after a request from the user.

13. The method of claim 12 further comprising:
receiving ranking information about each item identifier; and
using the ranking information to determine an order in which to display the electronic list of item identifiers of the on-line shelf.

14. The method of claim 12 further comprising:
causing an update to be posted on a social media platform featuring the on-line shelf, by accessing an application program interface (API) related to the social media platform.

15. The method of claim 12 further comprising:
periodically accessing the modulator module to determine if the on-line shelf has been modified; and
if the on-line shelf has been modified, causing information about the modified on-line shelf to be displayed.

16. The method of claim 12 wherein:
the on-line shelf further comprises a scheduled time configured to indicate a time at which the on-line shelf is to be modified; and
the method further comprises:
comparing a present time to the scheduled time; and
causing information about the modified on-line shelf to be displayed when the present time is past the scheduled time.

17. The method of claim 16 wherein:
the on-line shelf further comprises a version number; and
the method further comprises:
comparing the version number to a version number of an active on-line shelf; and
causing the on-line shelf with a higher version number to be displayed.

18. The method of claim 12 wherein:
the on-line shelf further comprises an expiration time configured to indicate a time after which the on-line shelf become inactive; and
the method further comprises:
preventing inactive on-line shelves from being displayed to the user.

19. The method of claim 12 wherein:
causing the information about each item identifier to be displayed comprises:
retrieving information associated with each item identifier to be displayed from an external database; and
transmitting the information associated with each item identifier in a format that is configured to be displayed to the user.

20. The method of claim 19 wherein:
the information associated with each item identifier includes description information and price information associated with each item identifier.
